(19) United States
(12) Patent Application Publication
(10) Pub. No.: US 2017/0270096 A1
(43) Pub. Date: Sep. 21, 2017

(54) METHOD AND SYSTEM FOR GENERATING LARGE CODED DATA SET OF TEXT FROM TEXTUAL DOCUMENTS USING HIGH RESOLUTION LABELING

(71) Applicant: Yissum Research Development Company of The Hebrew University of Jerusalem Ltd., Jerusalem (IL)

(72) Inventors: Tamir SHEAFER, Givatayim (IL); Shaul SHENHAV, Jerusalem (IL); Yair FOGEL-DROR, Mevaseret Tzion (IL)

(21) Appl. No.: 15/613,355

(22) Filed: Jun. 5, 2017

Related U.S. Application Data
(63) Continuation-in-part of application No. 15/226,967, filed on Aug. 3, 2016.
(60) Provisional application No. 62/200,723, filed on Aug. 4, 2015.

(51) Int. Cl. G06F 17/27; G06N 99/00; G06F 17/22

(52) U.S. Cl. CPC G06F 17/2745; G06F 17/2241; G06N 99/005

(57) ABSTRACT

A method and a system for generating coded dataset of sentences with a high resolution labeling are provided herein. The method may include: obtaining a plurality of textual documents that are pre-classified on a whole document level, into topics; training one or more mixed-membership model unsupervised algorithms, implemented by a computer processor, based on said topics, to yield a distribution of sub topics for each of the textual documents; and applying a transformation, implemented by a computer processor, to said distribution of sub topics for each of the textual documents, to yield a topic tagging score for said sub topics on a text-portion level.

### CROSS-REFERENCE TO RELATED APPLICATIONS

This application is a continuation-in-part application of U.S. patent application Ser. No. 15/226,967, filed Aug. 3, 2016, claiming priority of U.S. Provisional Patent Application No. 62/200,723, filed Aug. 4, 2015, both of which are hereby incorporated by reference in their entirety.

### FIELD OF THE INVENTION

The present invention relates generally to processing textual documents and, more particularly, to generating large coded data set of sentences from same.

### BACKGROUND OF THE INVENTION

Prior to the background of the invention being set forth, it may be helpful to set forth definitions of certain terms that will be used hereinafter.

The term “text-portion” as used herein is defined as any portion of a written article or document such as a paragraph, a page, a sentence or any other section in any length that is shorter than the entire article or document.

The term “topic naming” as used herein is defined as choosing a most appropriate name for each topic in a corpus of textual documents. Topic naming is carried out possibly by a human user but can also be carried out automatically.

The term “topic tagging” as used herein is defined as associating a text with predefined tags out of a predefined list of tags, based on relevance.

Classifying large amounts of texts based on a variety of criteria using computers is an ongoing challenge and serves a useful tool for quantitative textual research of Text classifying tasks known in the art include: framing and topic analysis, event identification and sentiment analysis. However, such computational text classifying methods are usually applied in low resolution (i.e., identify the general topic at the article level) and a lot of data that can be used for analysis is missing.

It would, therefore, be advantageous to be able to provide a method and a system for automatically classify texts in high resolution, such as on a single sentence level.

### SUMMARY OF THE INVENTION

A method and a system for generating coded dataset of sentences with a high resolution labeling are provided herein. The method may include: obtaining a plurality of collections of textual documents; training unsupervised learning models, implemented by a computer processor, using the collections of textual documents, to yield a distribution of sub topics for each of the collections of textual documents; applying a transformation, implemented by a computer processor, to the distribution of sub topics for each of the collections of textual documents, to yield a topic-tagging score for the sub topics on a sentences level; extracting collections of sentences with the highest score for each topic; labeling the topics based on their correspondent extracted sentences; tagging at least one of: the textual documents and sentences of the textual documents with the given labels; and using the labeled datasets to train a supervised algorithm.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a schematic block diagram illustrating a process according to some embodiments of the present invention;

FIG. 2 is schematic diagram illustrating an aspect according to some embodiments of the present invention;

FIG. 3 is schematic block diagram illustrating another aspect according to some embodiments of the present invention;

FIG. 4 is schematic block diagram illustrating another aspect according to some embodiments of the present invention; and

FIG. 5 is a high-level flowchart illustrating a method in accordance with embodiments of the present invention.

### DETAILED DESCRIPTION OF THE INVENTION

With specific reference now to the drawings in detail, it is stressed that the particulars shown are by way of example and for purposes of illustrative discussion of the preferred embodiments of the present technique only, and are presented in the cause of providing what is believed to be the most useful and readily understood description of the principles and conceptual aspects of the present technique. In this regard, no attempt is made to show structural details of the present technique in more detail than is necessary for a fundamental understanding of the present technique, the description taken with the drawings making apparent to those skilled in the art how the several forms of the invention may be embodied in practice.

Before at least one embodiment of the present technique is explained in detail, it is to be understood that the invention is not limited in its application to the details of construction and the arrangement of the components set forth in the following description or illustrated in the drawings. The present technique is applicable to other embodiments or of being practiced or carried out in various ways. Also, it is to be understood that the phraseology and terminology employed herein is for the purpose of description and should not be regarded as limiting.

For addressing the challenge of assessing sentiment of entities in documental texts, the inventors have used an attribute of political discourse being a high proportion of sentences that contain references to multiple entities, many times as a result of interactions between them. This attribute makes the sentence-proximity method less accurate, since the sentiment of the expression will be unintentionally attributed to all actors (usually this is not intended by the author).

Even methods utilizing a higher resolution known in the art, such as the 10-words-proximity method, may not always be sufficiently effective in assessing sentiment. For example, a given text describes how “Israel attacked Hamas” or “Hamas was attacked by Israel”. The author may intend to portray the State of Israel as an actor that acts aggressively, and, therefore, it is associated with a negative sentiment. The sentiment should be associated only with Israel as the agent of the action. However, current proximity methods would wrongly associate the sentiment with Hamas as well.

Furthermore, this attack can be described in the text in a slightly different way, such as “Hamas accuses Israel of attacking it”. In this example, the accusation is meant to address a negative sentiment towards Israel as the aggressor. As the distance of both entities from the sentiment expression is identical in each case, proximity methods would associate the sentiment with both entities instead of just one. The result would be false classifications of specific expressions and a more symmetric sentiment score for both entities in the document.

Some embodiments of the present invention aim to solve this problem. To achieve this, some embodiments of the present invention utilize a logic that resembles the task of semantic role labeling, where two major roles, the proto-agent and the proto-patient of the action, are considered.

The focus according to some embodiments of the present invention, however, is less on the semantic roles per se, but rather on the sentiment evoked toward the entities. In the example above, Israel is presented with a negative sentiment in all three cases, assuming this attack carries a negative sentiment. In the first two cases (“Israel attacked Hamas”; and “Hamas was attacked by Israel”), Israel serves as the agent of the aggressive action, and, therefore, the negative sentiment is safely associated with it. However, in the third case, where Hamas directly refers to Israel by accusing it, Israel serves as the patient of the accusation. This last case is usually interpreted as a judgment frame, where the agent is the judge, or as a quote, where the referring entity is the source. Either way, the agent in the cases of direct referencing says something negative or positive regarding the patient, and, therefore, the sentiment should be associated with the patient.

Consequently, associations made by some embodiments of the present invention are more accurate, even at the level of a single sentiment expression, and suffer less from false positives and artificially symmetrical scores in document-level analysis.

Some embodiments of the present invention assign each sentiment verb expression to a specific entity. An empirical demonstration carried out by the inventors was based, by way of illustration, on news coverage of the Israeli-Palestinian conflict. In this empirical demonstration, each sentiment verb expression is classified into one of four categories, according to the entities it targets: the State of Israel, the Palestinian Authority (PA), both, or neither. In line with methods for semantic role labeling, the method in accordance to some embodiments of the present invention begins by splitting sentences into clauses. It then identifies the entities mentioned in subjects and objects, including coreference resolution, and distinguishes between passive and active voices of the verb. Political entities of interest—Israel and the PA—are identified using a manually-built keyword dictionary. Tagging of sentiment expressions is performed using the Lexicoder Sentiment Dictionary. Lastly, cases of direct referencing are identified based on the Wordnet lexical group (super-sense) classification of the verbs.

Essentially, the method in accordance with some embodiments of the present invention uses four features: (1) entities identified in the subject of the clause in which the verb was found; (2) entities identified in the predicate of the clause; (3) the voice of the verb; and (4) in order to identify cases of direct referencing, a dichotomous flag indicating whether the Wordnet lexical group of the verb was communication, which mostly includes direct referencing verbs, and also most of the direct referencing verbs are included in it.

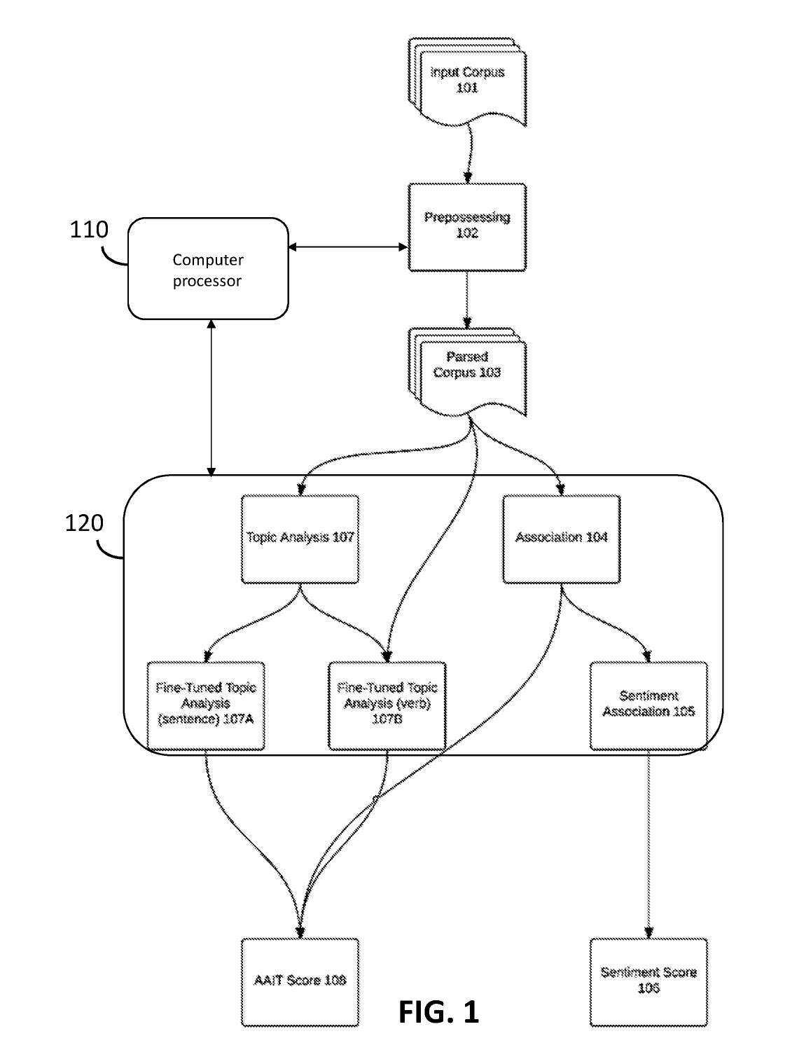

FIG. 1 is a high level block diagram illustrating the processing flow of the data in a system in accordance with some embodiments of the present invention implemented by a non-transitory computer readable medium 120 (e.g., a computer memory) executed by a computer processor 110. A corpus of documents 101 is pre-processed using several generic methods 102 executed by computer processor 110, ended as a parsed corpus 103. The parsed corpus is then processed using a learning algorithm for association 104 referred herein as a role-based association method, which is used for the sentiment association 105, resulted in an associated sentiment score for each entity 106. Combined with a topic analysis method 107 (or its fine-tuned version methods 107A and 107B), the role-based association method 104 is also used in order to associate the activity in the topic with the relevant entity, resulted in the AAIT score 108 (described below).

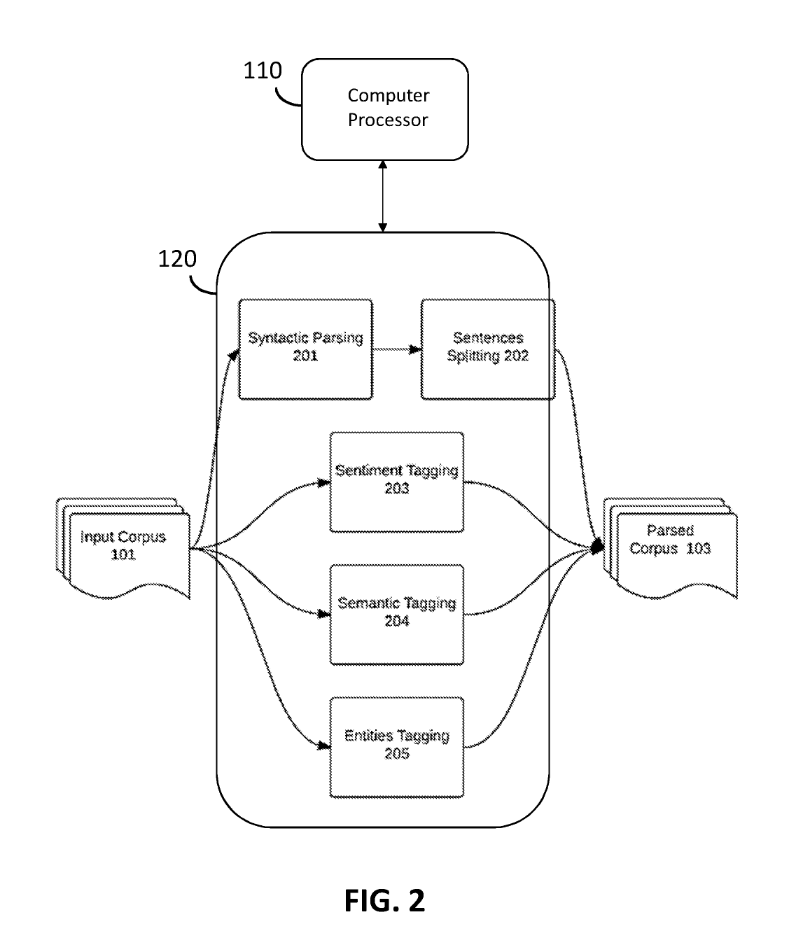

The preprocessing phase illustrated in a high-level block diagram in FIG. 2 includes several generic methods implemented in accordance with some embodiments of the present invention by a non-transitory computer readable medium 120 executed by a computer processor 110. Method 201 contains a standard syntactic parsing (lemmatization, POS tagging, dependencies parsing, coreference resolution, etc.) and is followed by a splitting method 202 in order to split complex sentences into clauses. The text is also tagged using a sentiment analysis method 203 where we are specifically interested in tagging verbs (e.g., positive and negative actions) which are also tagged using a semantic dictionary 204 (e.g., Wordnet super-senses) in order to get their general type. Last, references for entities are tagged using a similar method 205 (e.g., names of states, parties, politicians).

Tagging verbs with a sentiment analysis method can also be implemented in some embodiments of the present invention using a trained learning algorithm for sentiment analysis of verbs, in specific, or a sequence of words that includes the verb (e.g., a clause or the entire sentence). If a sequence of words is tagged, then all the verbs that are included in the sequence may carry the sentiment of the sequence for the purpose of the association.

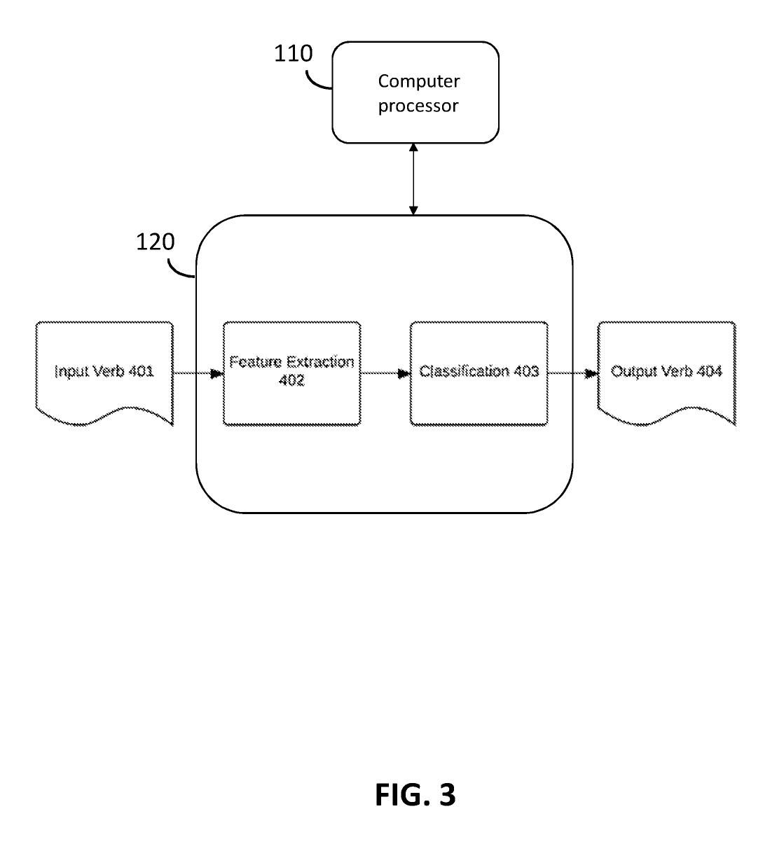

FIG. 3 illustrates role-based association method 104 in accordance with some embodiments of the present invention, implemented by a non-transitory computer readable medium 120 executed by a computer processor 110. It begins with a single verb 401 as an input and continues with a feature extraction method 402. For each verb, four features may be extracted: entities identified in the subject of the clause containing the verb, entities identified in the predicate of the clause containing the verb, the voice of the verb (active or passive) and the semantic type (e.g., Wordnet super-sense or lexical group) which is translated into a binary flag indicating whether the verb is a direct referencing type (e.g., the communication super-sense in Wordnet). These features are used in a trained learning algorithm for classification 403 (e.g., a decision tree or SVM). The output 404 is a verb, classified into the group of verbs that are to be associated with a specific entity (or a group of entities).

After all the verbs, and specifically the verbs which are also tagged with a sentiment score, are classified, the sentiment is associated with each entity 105. For each entity, sentiment scores from all verbs that are tagged as associated with this entity are summed up to create the entity's sentiment score 106.

Yet another challenge of applying sentiment analysis to a text containing a political discourse is taking into account the relation between the sentiment and the perspective. This is specifically challenging since almost anything in the political domain is evaluated differently from different perspectives or ideologies.

The indicator suggested by the inventors, in accordance with some embodiments of the present invention, is referred to herein as the Actor Activity in a Topic (AAIT) and tackles two questions regarding the text: (1) what is happening? (e.g., “a violent conflict between Israel and Iran”) and (2) what is the level of activity of each actor in this happening? (e.g., “Israel is active on an X level, Iran is active on a Y level”). At the end of the analysis, the researcher would be able to assess the level of activity of each actor in each topic. Then, it is for the researcher to decide whether an activity of a specific actor in a specific topic should be considered as a positive or negative image of this actor. By answering these questions only, the measure will not be able to exhaust the entire concept of evaluation, as we assume this is not fully feasible in political discourse. The new measure will only assist the researcher in the analysis process; nevertheless, it will result in a meaningful representation of what is being described in the text regarding the actor.

For the AAIT score to be calculated, a topic analysis method 106 such as one that adhere to the conventions of latent Dirichlet allocation (LDA) will be used as follows, but any sort of topic analysis or topic modeling method might serve this purpose, at the document level, resulted in a distribution of topics (Θ_{d}) for each text document d, probability of topic k occurring in document d (θ_{k,d}) and probability of word w occurring in topic k (φ_{k,w}).

Optionally, in order to achieve a higher resolution, an additional method for fine-tuned topic analysis at the sentence level 107A may be implemented. Specifically, the analysis at the sentence level 107A may include training a supervised classifier directly on sentences, in order to identify the specific topic (or distribution of topics) represented in the entire sentence. Using the aforementioned topic-tagged sentences may lead to a quicker training period where, in some embodiments of the present invention, a supervised model may be trained.

In accordance with some embodiments of the present invention, the process of topic analysis at the sentence level that is based on a topic model originally trained at the document level, is run for each sentence in separate, starting by calculating a score P′_{k,s} to represent the topic-tagging score of each topic k occurring in sentence s using equation (1) as follows:

P′_{k,s}=θ_{k,d}*Σ_{w in s}φ_{k,w} (1)

For each topic k in the distribution of topics Θ_{d}, an topic-tagging score of the topic in the sentence s (P′_{k,s}) is obtained by multiplying the proportion of the topic k in the article d (θ_{d,k}) with the sum of relevant phi values for each word w in the sentence (φ_{k,w}). When a fine tuning version of method 107 is not used, each sentence in the document will get the same distribution of topics as in the document as a whole (Θ_{d}).

According to some embodiments of the present invention, a supervised algorithm may be used for determining topics so that the AAIT_{k,e} score is calculated as a sum of the sentences (or other textual portion) identified in topic k and associated with entity e.

In this case, and as will be described in further details hereinafter, the supervised algorithm can be trained using human coded sentences. Alternatively, equation (1) which indicates relevance of a sentence to a specified topic, may be used. Thus, it would be possible to generate a large coded data set of sentences, with a high resolution labeling in terms of the differentiation between topics, events, perspectives, and the like. While generating the dataset of coded sentences, the supervised learning algorithms is being trained for determining sentences' topics. Then, the identification is used for calculating the AAIT score.

Another alternative for the topic analysis fine tuning is to create a topic tag for each verb in the text 107B. For that purpose, the topic k with highest probability of the word w to occur in topic k (φ_{k,w}) can be chosen. Alternatively, a simple dictionary method can be used, where each verb is tagged with a specific predetermined topic. In the latter case, method 107 can be skipped, as each verb can be tagged for topics directly using the dictionary, without the need to create a topic model first using the whole corpus. The output of the topic analysis method 107, or one of its fine-tuned version 107A or 107B, is used in combination with the association method 104 in order to associate the activity in the topic with the relevant entity, resulted in the AAIT score 108. First, the associated entity of each verb resulted from method 104 is considered as the active entity in that verb. Second, when the topic k is tagged at the sentence level (methods 107 or 107A), each entity that was tagged as active in one of the verbs in the sentence, is tagged as an active entity in the topic k for this sentence. This results with the activity indicator A_{e,s} where its value is 1 if entity e was marked as an active entity in sentence s, and 0 otherwise. After all sentences in the document are tagged using this method, the AAIT score can be calculated for each entity e in topic k (AAIT_{k,e}) as the sum of the topic-tagging scores of topic k in all sentences in the document d using equation (2) as follows:

AAIT_{k,e}=Σ_{s in d} P′_{k,s}*A_{e,s} (2)

Otherwise, when the topic k is tagged directly for each verb, using method 107B, the entity that was tagged as active in that verb would be tagged as the active entity in the topic k. After tagging the active entities and topic for all verbs in the document, the AAIT_{k,e} score can be calculated as a sum (or a weighted sum) of all relevant verbs.

Generating a Large Coded Data Set of Sentences, with a High Resolution Labeling

According to the aforementioned embodiment of the present invention, it is suggested herein to use the transformation of the aforementioned equation (1) for generating a large coded data set of sentences, with a high resolution labeling in terms of the differentiation between topics, events, perspectives, and the like.

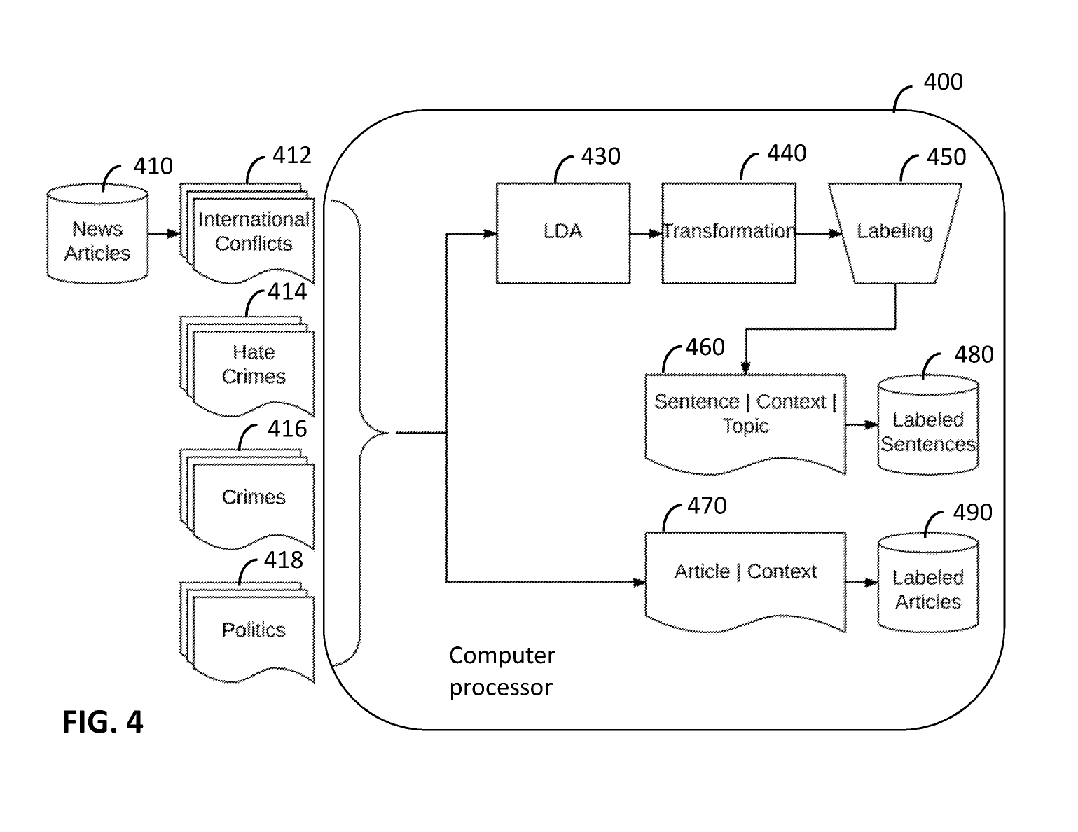

FIG. 4 is a block diagram illustrating a computerized system for generating a large coded data set of sentences, with a high resolution labeling. The system may receive as an input, from a database 410 of textual documents, some pre-classified collections of textual document such as 412, 414, 416, and 418 wherein the classification (whether manual or automatic) is based on topics.

Each of these pre-classified collections of textual document such as 412, 414, 416, and 418 is fed into a separate unsupervised clustering algorithm for topic modeling, such as Latent Dirichlet Allocation (LDA) 430 implemented on a computer processor 410. The inventors have discovered that it is advantageous to train the topic model on a corpus with a specific broad subject (e.g., American politics, international conflicts, sports) in order to achieve better results, although it is not mandatory. By doing so, the algorithm is more likely to model topics which are easier to interpret or label. Hence the pre-classification that has yielded clusters of textual document such as 412, 414, 416, and 418.

According to some embodiments of the present invention, a general subject (e.g. international conflicts, hate crimes, crime, and politics) together with the respective collected documents such as 412, 414, 416, and 418 respectively may be used in order to create a dataset of labeled documents. The document-level dataset may be used later by the classification method, as a means to identify the general context of the document in which the sentence to be classified is found. The process described herein may be performed on several corpora, each with a general subject.

As indicated above, any mixed membership model can be used to model documents in their entirety. LDA module 430 is a non-limiting example for a mixed-membership model that may be used in order to implement embodiments of the present invention.

In a mixed-membership model, instead of assigning each document into one cluster or group of documents (which might represent a topic if that was the case), it assumes that each document contains a distribution of topics. Hence, a topic is defined as a distribution over the vocabulary—the collection of all analyzed words, after standard preprocessing steps (e.g., lemmatization and removal of stop-words, common and rare terms). For example, terms like ‘shoot’, ‘tank’, and ‘soldiers’ will be more common in a war topic, compared to ‘house’, ‘peace’, and ‘fruit’. The output of the topic model is twofold: a distribution of the vocabulary for every topic, and a distribution of topics in each document.

Then, the foundations of obtaining a higher resolution is achieved by moving from the article to the sentence level of analysis. This results in a richer information found at the article level while training the topic model, as well as a higher resolution of analysis enabled by the sentence level.

According to some embodiments of the present invention, the proportion of the topic in each document and a distribution over the vocabulary (being the output of the LDA module) are applied to a transformation module 440 implanting on computer processor 410 a similar or equivalent of aforementioned equation (1).

Transformation module 440 yields an indication for the level of relevance each topic received at the sentence level. Specifically, the transformation module 440 attempts to take into consideration both the distribution of topics at the article and the distribution of topics over the vocabulary.

More formally, LDA module 430 is resulted in a distribution of topics (Θ_{d}) for each text document d, probability of topic k occurring in document d (θ_{k,d}) and probability of word w occurring in topic k (φ_{k,w}). For each sentence, transformation module 440 calculates a score P′_{k,s} to represent the topic-tagging score of each topic k occurring in sentence s using aforementioned equation (1) reproduced herein for convenience:

$${P}_{k , s}^{′} = {θ}_{k , d} * {\sum }_{w i n s} {ϕ}_{k , w} \qquad ( 1 )$$

For each topic k in the distribution of topics in the document (Θ_{d}), a topic-tagging score (φ_{k,s}) may be received by multiplying the proportion of the topic k in the article d (θ_{d,k}), by the sum of relevant phi values for each word w in the sentence (100 _{k,w}). The result is a fine-tuned topic-tagging score of topics for every sentence (in the sense of how much a sentence is associated with a specified topic), as opposed to the original version of LDA, which results in the same distribution of topics as in the document as a whole (Θ_{d}).

Then it is possible to go over the different topics and extract the sentences with the highest scores for each of the topics (the inventors have found the threshold of 2 to 3 standard deviations above the mean as a useful threshold, but this is likely to differ by case).

Using these sentences and the most probable words for the topic, it may be possible to apply topic naming (choosing a most appropriate name for each topic, possibly by a human user but can also be carried out automatically) to quite easily compare to a topic naming process based on the original LDA results (i.e. without using transformation module 440).

Using the new labels, the entire set of extracted sentences may be easily labeled by labeling module 450 possibly to end up with two labeled datasets. The first dataset 490 (possibly implemented on a computer memory associated with computer processor 410) contains whole articles with a specific context by which they were collected (the general subject of the collection of documents). Dataset 490 may be used in order to train a simple classification algorithm for classifying articles to the general context.

In accordance with some embodiments of the present invention, the second dataset 480 (possibly implemented on a computer memory associated with computer processor 410) may contain sentences with the specific context by which the correspondent articles were collected, along with the specific high-resolution label obtained from training LDA module 430 and transformation module 440. Dataset 480 may be used for the training of a supervised learning algorithm described hereinafter, for classifying sentences.

In accordance with some embodiments of the present invention, the entire process may be run multiple times—one for each context. Each context gives us the possibility to model and identify related topics, where each topic can serve as a “context” for a new dataset of collected articles—to be further analyzed.

With separating between the labeling of sentences using an unsupervised algorithm (LDA) and the training of the supervised algorithm, control over the process is achieved.

It is up to the end user-researcher to decide when to add more topics and when to split a topic into sub-topics in order to get a better resolution of analysis. In addition, as the output of the system in accordance with embodiments of the present invention is merely a dataset, more data can be added manually by the researcher. A classic scenario would be to use bootstrapping, where the computerized system may be to classify texts, then give sentences with high probability of classification to human coders and update the training-set with new (manually) labeled text examples.

Once the labeled datasets 480 and 490 for sentences and articles respectively are established, the process may continue with yet another embodiment—the classification of sentences. This can be done by any supervised algorithm, especially where the researcher is only interested in classifying a small number of categories (e.g., up to 15).

Some embodiments of the present invention may allow the classification of a large number of categories. Therefore it is recommended to train a deep neural network as will be explained in further details hereinafter.

In any case, as sentences sometime do not contain enough information, it may be better to use information from the document in order to improve the classification accuracy. One alternative is to include the entire text of the document as one of the sources of the learning algorithm Accordingly, in a simpler approach, where instead of the entire text, the sentence-classification algorithm uses only the general context of the document. Additionally, further insight may be derived by analyzing the sentences that are adjacent to a specified sentence that is being analyzed.

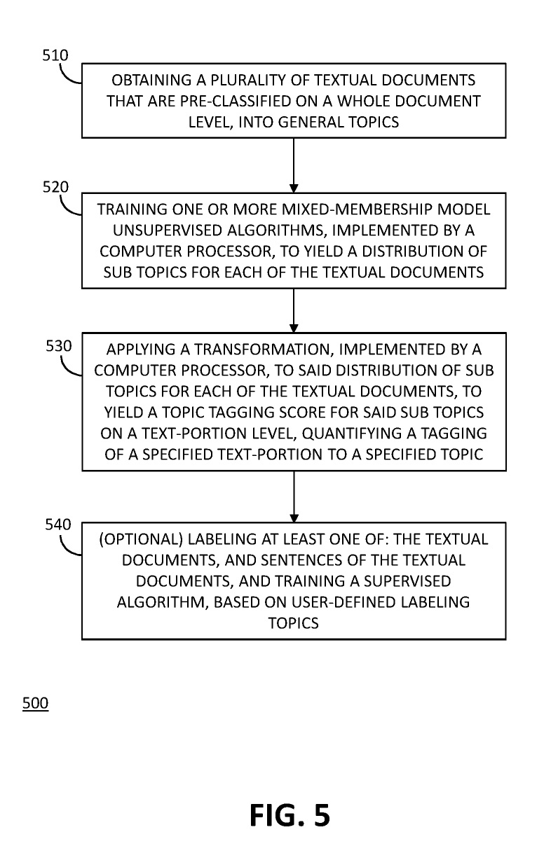

By way of summarizing and generalizing the aforementioned embodiment of labeling documents on a sentence-level resolution, FIG. 5 is a flowchart illustrating a method 500 implementing a generalized non-limiting embodiment of the aforementioned invention. Method 500 may include the following steps: obtaining a plurality of clustered textual documents, wherein the clustering associates a general topic of the textual documents per cluster 510; training a mixed-membership model unsupervised algorithm, implemented by a computer processor, using the collected textual documents, to yield a distribution of sub topics for each of the textual documents 520; applying a transformation, implemented by a computer processor, to the distribution of sub topics for each of the textual documents, to yield a proportion for the sub topics on a sentences level 530; and tagging at least one of: the textual documents, and portions of the textual document 540.

According to some embodiments of the present invention, a non-transitory computer readable medium may implement aforementioned method 500. In order to implement method 500 according to some embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, some aspects of the present invention may be embodied as a system, method or computer program product. Accordingly, some aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some aspects of the present invention are described above with reference to flowchart illustrations and/or portion diagrams of methods, apparatus (systems) and computer program products according to some embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that, where the claims or specification refer to “a” or “an” element, such reference is not be construed that there is only one of that element.

It is to be understood that, where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of topic labeling of textual documents on a text-portion level, the method comprising:
obtaining a plurality of textual documents that are pre-classified on a whole document level, into general topics;
training one or more mixed-membership model unsupervised algorithms, implemented by a computer processor, to yield a distribution of sub topics for each of the textual documents; and
applying a transformation, implemented by a computer processor, to said distribution of sub topics for each of the textual documents, to yield a topic tagging score for said sub topics on a text-portion level, quantifying a tagging of a specified text-portion to a specified topic.

2. The method according to claim 1, further comprising labeling at least one of: said textual documents, and sentences of said textual document, and training a supervised algorithm, based on user-defined labeling topics.

3. The method according to claim 1, wherein the mixed-membership model unsupervised algorithm is Latent Dirichlet Algorithm (LDA).

4. The method according to claim 1, wherein the obtaining a plurality of textual documents comprises clustering the textual documents automatically.

5. The method according to claim 1, wherein the transformation applies to a probabilistic model of the sub topics presented in the textual documents while using the identified relationship between entities and verbs and a respective determined topic associated with the verbs to determine for each of the plurality of entities, taking into account a probability of each of the topic in a respective sentence.

6. The method according to claim 1, wherein the transformation comprises computing a level of association of the sentence, or a section of the article, with a topic, by combining the words found in the sentences, and the context of the entire article.

7. The method according to claim 1, wherein the transformation comprises a combination of the proportions of each word from the specific sentence in the topic, with the proportion of the topic in the entire document, wherein said proportion of word in topic comprise at least one of: a general proportion of the word in the topic, or the proportion of the specific instance of word within the specific document, in the topic, as calculated by the topic model.

8. The method according to claim 1, wherein the transformation is based on:
$${P}_{k , s}^{′} = {θ}_{k , d} * {\sum }_{w in s} {ϕ}_{k , w}$$
wherein P′_{k,s} represents a topic-tagging score of each sub topic k occurring in sentence s, wherein θ_{k,d} denotes probability of sub topic k occurring in document d and wherein φ_{k,w} denotes a probability of word w occurring in sub topic k, wherein the topic-tagging score indicates distribution of sub topics for each of the textual documents.

9. A system of text-portion level topic labeling of textual documents, the system comprising:
a memory configured to obtain a plurality of clustered textual documents, wherein the clustering associates a general topic of the textual documents per cluster; and
a computer processor configured to
train a mixed-membership model unsupervised algorithm, using said clustered textual documents, to yield a distribution of sub topics for each of the textual documents; and
apply a transformation, implemented by a computer processor, to said distribution of sub topics for each of the textual documents, to yield a topic-tagging score for said sub topics on a text portion level, quantifying a tagging of a specified text-portion with a specified topic.

10. The system according to claim 9, further comprising a labeling module configured to label at least one of: said textual documents, and sentences of said textual document, to train a supervised algorithm, based on user-defined labeling topics.

11. The system according to claim 9, wherein the mixed-membership model unsupervised algorithm is Latent Dirichlet Algorithm (LDA).

12. The system according to claim 9, wherein the clustered textual documents are classified automatically.

13. The system according to claim 9, wherein the transformation applies to a probabilistic model of the sub topics presented in the textual documents while using the identified relationship between entities and verbs and a respective determined topic associated with the verbs to determine for each of the plurality of entities, taking into account a probability or tagging of each of the topics in a respective sentence.

14. The system according to claim 9, wherein the transformation comprises computing a level of association of the sentence with a topic, by combining the words found in the sentences, and the context of the entire article.

15. The system according to claim 9, wherein the transformation comprises a combination of the proportions of each word from the specific sentence in the topic, with the proportion of the topic in the entire document, wherein said proportion of word in topic comprise at least one of: a general proportion of the word in the topic, or the proportion of the specific instance of word within the specific document, in the topic, as calculated by the topic model.

16. The system according to claim 9, wherein the transformation is based on:
$${P}_{k , s}^{′} = {θ}_{k , d} * {\sum }_{w i n s} {ϕ}_{k , w}$$
wherein P′_{k,s} represents a topic-tagging score of each sub topic k occurring in sentence s, wherein θ_{k,d} denotes probability of sub topic k occurring in document d and wherein φ_{k,w} denotes a probability of word w occurring in sub topic k, wherein the topic-tagging score indicates distribution of sub topics for each of the textual documents.

17. A non-transitory computer readable medium for topic labeling of textual documents on a text-portion level, the computer readable medium comprising a set of instructions that when executed cause at least one computer processor to:
obtain a plurality of collections of textual documents, wherein the classification associates a general topic of the textual documents per collection;
train a mixed-membership model unsupervised algorithm, using said collections of textual documents, to yield a distribution of sub topics for each of the textual documents; and
apply a transformation, implemented by a computer processor, to said distribution of sub topics for each of the textual documents, to yield a tagging score for said sub topics on a text-portion level, quantifying an association of a specified text-portion to a specified topic.

18. The non-transitory computer readable medium according to claim 17, further comprising a labeling module configured to label at least one of: said textual documents, and sentences of said textual document, to train a supervised algorithm, based on user-defined labeling topics.

19. The non-transitory computer readable medium according to claim 17, wherein the mixed-membership model unsupervised algorithm is Latent Dirichlet Algorithm (LDA).

20. The non-transitory computer readable medium according to claim 17, wherein the clustered textual documents are classified automatically.
